(19) United States
(12) Patent Application Publication
(10) Pub. No.: US 2026/0126920 A1
(43) Pub. Date: May 7, 2026

(54) STORAGE DEVICE, HOST DEVICE, AND STORAGE SYSTEM INCLUDING THE SAME

(71) Applicant: SAMSUNG ELECTRONICS CO., LTD., Suwon-si (KR)

(72) Inventors: Won Hee CHO, Suwon-si (KR); Mungyu BAE, Suwon-si (KR); Jisoo KIM, Suwon-si (KR); Younsung CHU, Suwon-si (KR)

(73) Assignee: SAMSUNG ELECTRONICS CO., LTD., Suwon-si (KR)

(21) Appl. No.: 19/300,937

(22) Filed: Aug. 15, 2025

(30) Foreign Application Priority Data
Nov. 7, 2024 (KR) 10-2024-0157038

(51) Int. Cl. G06F 3/06

(52) U.S. Cl. CPC G06F 3/0622; G06F 3/0655; G06F 3/0679

(57) ABSTRACT

In a storage device including a host device and a storage device, the host device includes a host memory and a host security manager to manage security of the host device and transmit a triplet request to the storage device. The storage device includes a non-volatile memory, and a storage controller including a device security manager to manage security of the storage device, generate a triplet and store the triplet in the non-volatile memory, and transmit the triplet or partial triplets generated based on the triplet to the host security manager, in response to receiving the triplet request from the host security manager. The triplet includes a pair of numbers containing three numbers for performing a multiplication operation through a multi-party computation in the host device, and the partial triplets contain secret shared values of the triplet, which are distributed to participants of the multi-party computation.

### CROSS-REFERENCE TO RELATED APPLICATION

This application claims priority to Korean Patent Application No. 10-2024-0157038, filed in the Korean Intellectual Property Office on Nov. 7, 2024, the entire contents of which are hereby incorporated by reference.

### BACKGROUND

### Field

The present disclosure relates to a storage device, a host device, and a storage system including the same.

### Description of Related Art

Multi-party computation (MPC) is a technology that allows multiple parties to perform joint computations without exposing personal data. The multi-party computation (MPC) may be widely used in a variety of application fields that require cooperative computation while protecting sensitive data. These technologies may be used in areas such as finance, healthcare data processing, privacy-preserving computing, and machine learning model training using private data, and are especially useful when data security and privacy are important.

In order to perform a multiplication operation in a multi-party computation, a pre-generated triplet is required. A triplet is a tool that helps participants in a multi-party computation perform multiplication operations without exposing their data. If the triplet is exposed externally, there is a risk that private data of multiple parties will be exposed. Therefore, the creation and management of triplets should be performed by a reliable configuration.

In general, one triplet is consumed for each multiplication operation, so a very large number of triplets are required for multi-party computations. This requires that a large number of triplets be generated in advance to handle large-scale computational tasks. However, if a computation device participating in the multi-party computation directly creates and manages triplets, the resources of the computation device may be excessively consumed. This has the problem that it may lead to performance degradation and resource limitation issues on the computation device.

The above-described information is intended to enhance understanding of the background of the present disclosure and may include information that does not constitute prior art.

### SUMMARY

The present disclosure relates to a storage device, a host device, and a storage system including the same for solving the above problems.

The problems to be solved by the present disclosure are not limited to those described above, and other problems not mentioned may be clearly understood by those skilled in the art from the description of the disclosure below.

According to some aspects, a storage system includes a host device, and a storage device configured to transmit and receive data with the host device. Here, the host device includes a host memory, and a host security manager configured to manage security of the host device and to transmit a triplet request to the storage device. Here, the storage device includes a non-volatile memory, and a storage controller including a device security manager configured to manage security of the storage device, generate a triplet and store the triplet in the non-volatile memory, and transmit the triplet or partial triplets generated based on the triplet to the host security manager, in response to receiving the triplet request from the host security manager. Herein, the triplet includes a pair of numbers containing three numbers for performing a multiplication operation through a multi-party computation (MPC) in the host device, and the partial triplets contain secret shared values of the triplet, which are distributed to participants of the multi-party computation.

According to some aspects, a storage device include a non-volatile memory, and a device security manager configured to manage security of the storage device and to perform mutual authentication with a host security manager of a host device configured to transmit and receive data with the storage device. Here, the device security manager is configured to generate a triplet and store the generated triplet in the non-volatile memory, and transmit the triplet or partial triplets generated based on the triplet to the host security manager, in response to receiving the triplet request from the host security manager. Here, the triplet includes a set of numbers containing three numbers for performing a multiplication operation through a multi-party computation in the host device, and the partial triplets include secret shared values of the triplet, which are distributed to participants of the multi-party computation.

According to some aspects, a host device includes a host memory, and a host security manager configured to manage security of the host device and to perform mutual authentication with a device security manager of a storage device configured to transmit and receive data with the host device. Here, the host security manager is further configured to transmit a triplet request to the device security manager, and receive a triplet or partial triplets generated based on the triplet, from the device security manager, and the triplet includes a set of numbers containing three numbers for performing a multiplication operation through a multi-party computation in the host device. Here, the partial triplets include secret shared values of the triplet, which are distributed to participants of the multi-party computation.

According to various embodiments of the present disclosure, as a storage device performs generation and management of triplets for multi-party computations by offloading, resources of a host device may be saved, processing speed may be improved, and performance may be optimized. Additionally, the efficiency of the storage system may be increased by generating triplets while the storage device is not performing data writing/reading.

The effects that may be obtained through the present disclosure are not limited to those described above. Any technical effects not mentioned will be clearly understood by those skilled in the art from the description of the disclosure set forth below.

### BRIEF DESCRIPTION OF THE DRAWINGS

The above and other embodiments and features of the present disclosure will become more apparent by describing in detail example embodiments thereof with reference to the attached drawings, in which:

FIG. 1 is an exemplary block diagram illustrating a storage system according to one embodiment of the present disclosure.

FIG. 2 is an exemplary block diagram illustrating a host device performing multi-party computations according to one embodiment of the present disclosure.

FIG. 3 is a block diagram illustrating an example of a storage system for performing multi-party computations according to one embodiment of the present disclosure.

FIG. 4 is a flowchart illustrating an example of a method of operating a storage device according to one embodiment of the present disclosure.

FIG. 5 is a flowchart illustrating an example of a method of operating a host device according to one embodiment of the present disclosure.

FIG. 6, FIG. 7, FIG. 8 and FIG. 9 are block diagrams illustrating examples of the operation of a storage system according to one embodiment of the present disclosure.

FIG. 10 and FIG. 11 are diagrams illustrating examples of a method of operating a storage system according to some embodiments of the present disclosure.

FIG. 12 is a diagram illustrating an example of an operating method of a storage system according to another embodiment of the present disclosure.

FIG. 13 is a diagram illustrating an example of a method of operating a storage system according to another embodiment of the present disclosure.

FIG. 14 and FIG. 15 are diagrams illustrating examples of a method of operating a storage system according to further other embodiments of the present disclosure.

FIG. 16 is an exemplary block diagram illustrating a storage system according to one embodiment of the present disclosure.

FIG. 17 is an exemplary block diagram illustrating a data center to which a storage device according to one embodiment of the present disclosure is applied.

### DETAILED DESCRIPTION

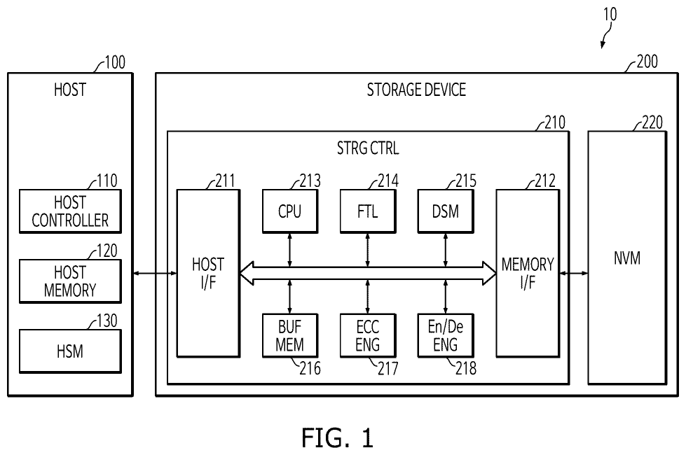

Hereinafter, various embodiments of the present disclosure will be described with reference to FIGS. 1 to 17. Throughout the specification, the same reference numerals may refer to the same components.

FIG. 1 is an exemplary block diagram illustrating a storage system according to one embodiment of the present disclosure. Referring to FIG. 1, the storage system 10 may include a host device 100 and a storage device 200 configured to transmit and receive data with the host device 100.

According to one embodiment, the host device 100 may include a host controller 110 and a host memory 120. In one embodiment, the host memory 120 may function as a buffer memory for temporarily storing data to be transmitted to the storage device 200 or data transmitted from the storage device 200, but the embodiment is not limited to this example.

According to one embodiment, the host controller 110 and the host memory 120 may be implemented as separate semiconductor chips. Alternatively, the host controller 110 and host memory 120 may be integrated into the same semiconductor chip. For example, the host controller 110 may be one of a number of modules provided in an application processor, and the application processor may be implemented as a system on chip (SoC). Additionally, the host memory 120 may be an embedded memory provided within the application processor and/or a non-volatile memory or memory module located outside the application processor.

The host controller 110 may manage an operation of storing data (e.g., write data) from a buffer area of the host memory 120 into the non-volatile memory 220, or storing data (e.g., read data) from the non-volatile memory 220 into the buffer area.

According to one embodiment, the host device 100 may further include a host security manager 130. The host security manager 130 may include hardware and/or software modules that manage the security of the host device 100. Although the host security manager 130 is shown as a separate component from the host controller 110 and the host memory 120, the scope of the present disclosure is not limited thereto, and the host security manager 130 may be included in the host controller 110 and/or the host memory 120.

According to one embodiment, the storage device 200 may include a storage controller 210 and a non-volatile memory (NVM) 220. The storage device 200 may include storage media for storing data upon request from the host device 100. For example, the storage device 200 may include at least one of a solid state drive (SSD), an embedded memory, and a removable external memory, but the embodiment is not limited to this example.

If the storage device 200 is an SSD, the storage device 200 may be a device that follows the non-volatile memory express (NVMe) standard. If the storage device 200 is an embedded memory or an external memory, the storage device 200 may be a device that follows the universal flash storage (UFS) or embedded multi-media card (eMMC) standard. The host device 100 and the storage device 200 may each generate packets according to the adopted standard protocol and transmit the generated packets.

When the non-volatile memory 220 of the storage device 200 includes a flash memory, the flash memory may include a 2D NAND memory array and/or a 3D (or vertical) NAND (VNAND) memory array. Additionally or alternatively, the storage device 200 may include various other types of non-volatile memories. For example, the storage device 200 may include magnetic RAM (MRAM), spin-transfer torque MRAM, conductive bridging RAM (CBRAM), ferroelectric RAM (FeRAM), phase RAM (PRAM), resistive RAM, and other various types of memories.

The storage controller 210 may write data to the non-volatile memory 220 or read data stored in the non-volatile memory 220 upon request from the host device. Additionally, the storage controller 210 may manage data stored in non-volatile memory 220 so that the data is not damaged.

According to one embodiment, the storage controller 210 may include a host interface 211, a memory interface 212, and a central processing unit (CPU) 213. Additionally, the storage controller 210 may further include a flash translation layer (FTL) 214, a device security manager 215, a buffer memory 216, an error correction code (ECC) engine 217, and an encryption/decryption engine 218. The storage controller 210 may further include a working memory (not shown) into which a flash translation layer (FTL) 214 is loaded, and data writing and reading operations for the non-volatile memory 220 may be controlled by the CPU 213 executing the flash translation layer (FTL) 214.

The host interface 211 may transmit and receive packets with the host device 100. A packet transmitted from a host device 100 to a host interface 211 may include a command or data to be recorded in a non-volatile memory 220, and a packet transmitted from the host interface 211 to the host device 100 may include a response to a command or data which is read from the non-volatile memory 220. The memory interface 212 may transmit data to be written to the non-volatile memory 220 to the non-volatile memory 220 or receive data which is read from the non-volatile memory 220. Such a memory interface 212 may be implemented to comply with standard protocols such as Toggle or open NAND flash interface (ONFI).

The flash translation layer 214 may perform various functions such as address mapping, wear-leveling, and garbage collection. The address mapping operation may refer to an operation of changing a logical address received from a host device 100 into a physical address used to actually store data in the non-volatile memory 220. The wear-leveling operation may refer to an operation to prevent excessive deterioration of a specific block by allowing blocks within a non-volatile memory 220 to be used uniformly, and may be implemented, for example, through firmware technology that balances erase counts of physical blocks. The garbage collection may refer to an operation to secure available capacity within a non-volatile memory 220 by copying valid data of a block to a new block and then erasing the existing block.

The ECC engine 217 may perform error detection and correction functions for read data which is read from the non-volatile memory 220. More specifically, the ECC engine 217 may generate parity bits for the write data to be written in the non-volatile memory 220, and the parity bits thus generated may be stored in the non-volatile memory 220 together with the write data. When reading data from the non-volatile memory 220, the ECC engine 217 may correct errors in the read data using parity bits which is read from the non-volatile memory 220 together with the read data, and may output the error-corrected read data.

The device security manager 215 may include hardware and/or software modules that manage the security of the storage device 200. The device security manager 215 is shown as being included in the storage controller 210, but the scope of the present disclosure is not limited thereto, and the device security manager 215 may be included in the host controller 110 and/or host memory 120.

The buffer memory 216 may temporarily store data to be written to the non-volatile memory 220 or data to be read from the non-volatile memory 220. Additionally, although the buffer memory 216 is illustrated as being included within the storage controller 210, the scope of the present disclosure is not limited thereto, and the buffer memory 216 may be placed outside the storage controller 210. The buffer memory 216 may be, for example, a Dynamic Random Access Memory (DRAM), but the embodiment is not limited to this example.

The encryption/decryption engine 218 may perform an encryption operation and/or a decryption operation on data which is input to the storage controller 210. For example, the encryption/decryption engine 218 may perform an encryption operation and/or a decryption operation on data which is input to the storage controller 210 using a symmetric key algorithm.

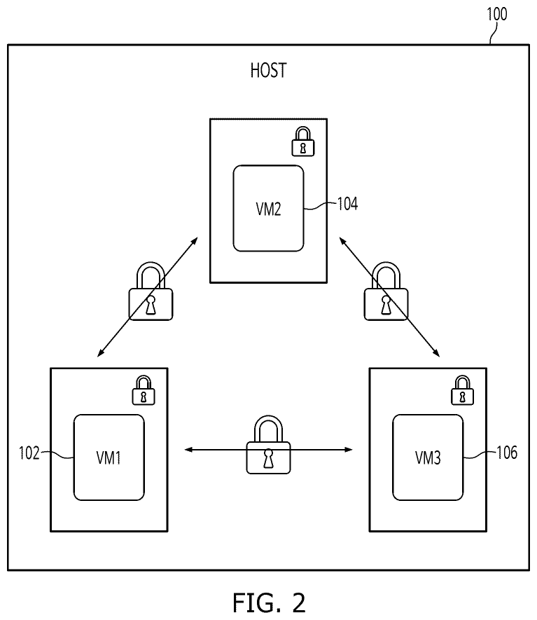

FIG. 2 is an exemplary block diagram for explaining a host device 100 that performs multi-party computation (MPC) according to one embodiment of the present disclosure. In one embodiment, a plurality of tenants 102, 104 and 106 may use the host device 100 to perform multi-party computations. In some embodiments of the present disclosure, the tenants 102, 104 and 106 may refer to a tenant itself (e.g., a user or a group of users) and/or a virtual machine associated with the tenant. Here, the virtual machine may refer to an independent computer environment associated with each tenant 102, 104 or 106. For example, the virtual machine may refer to at least a part of a host controller (e.g., 110 of FIG. 1) that processes data associated with each tenant 102, 104 or 106 and/or at least a part (e.g., a host memory area associated with each tenant 102, 104 or 106) of a host memory (e.g., 120 of FIG. 1) where data associated with each tenant 102, 104 or 106 is stored, etc.

The multi-party computation may refer to the cooperation of multiple parties to perform computations without sharing the personal data owned by each party. A primary goal of multi-party computation may be to obtain the required computational results while protecting personal data from exposure. For example, multi-party computations may be applied to tasks in which a plurality of tenants 102, 104 and 106 jointly train a machine learning model while protecting personal information, tasks in which a plurality of tenants 102, 104 and 106 analyze data while protecting personal information, and secret voting tasks, etc.

In some embodiments, participants in a multi-party computation (e.g., tenants 102, 104 and 106) may require a triplet to safely process a multiplication operation. A triplet is a tool that allows participants in a multi-party computation to perform multiplication operations safely without exposing their data, and may contain three numbers (e.g., three integers). For example, a triplet may be expressed by mathematical formula 1 below.

$$\begin{matrix}t = ( a , b , c ) , & where c = a \times b\end{matrix} \qquad [ Mathematical Formula 1 ]$$

That is, a triplet may contain three numbers, where one number is the product of the other two numbers.

In order to allow the participants of a multi-party computation to perform a multiplication operation, each participant may share one of secret shared values of the triplet. In the present disclosure, the secret shared values of the triplets distributed to the participants of the multi-party computation may be referred to as “partial triplet(s)”. The sum of the partial triplets distributed to each participant may be a triplet. For example, partial triplets may be expressed by the following mathematical formula 2.

$$t 1 = ( a 1 , b 1 , c 1 ) , t 2 = ( a 2 , b 2 , c 2 ) , … , \qquad [ Mathematical Formula 2 ]$$

$$tn = ( an , bn , cn ) , where a = a 1 + a 2 + … + an ,$$

$$b = b 1 + b 2 + … + bn , c = c 1 + c 2 + … + cn$$

Here, n may represent the number of participants in a multi-party computation. If the partial triplets are expressed again, the partial triplets may be expressed as the following mathematical formula 3.

$$t 1 = ( {p}_{1} , {q}_{1} , {r}_{1} ) , t 2 = ( {p}_{2} , {q}_{2} , {r}_{2} ) , … , \qquad [ Mathematical Formula 3 ]$$

$$tn = ( a - {p}_{1} - {p}_{2} - … - {p}_{n - 1} , b - {q}_{1} - {q}_{2} - … - {q}_{n - 1} , c - {r}_{1} - {r}_{2} - … - {r}_{n - 1} ) ,$$

Here, n may represent the number of participants in a multi-party computation, and Pₖ, qₖ and rₖ may represent any value. That is, when using a triplet and 3(n−1) random values, n partial triplets may be generated. Each participant may perform operations using the partial triplet distributed to the participant, and through this, the multiplication operation of the multi-party computation may be performed.

In order for the multi-party computation to be performed securely, triplets and partial triplets should not be exposed, so a trusted device within the system should generate and manage triplets and partial triplets, which need to be stored in a security region. Additionally, because one triplet is consumed for each multiplication operation, a very large number of triplets should be generated and stored in advance. However, there may be a resource limitation for the host device 100 to perform all of the creation, storage, and management of triplets.

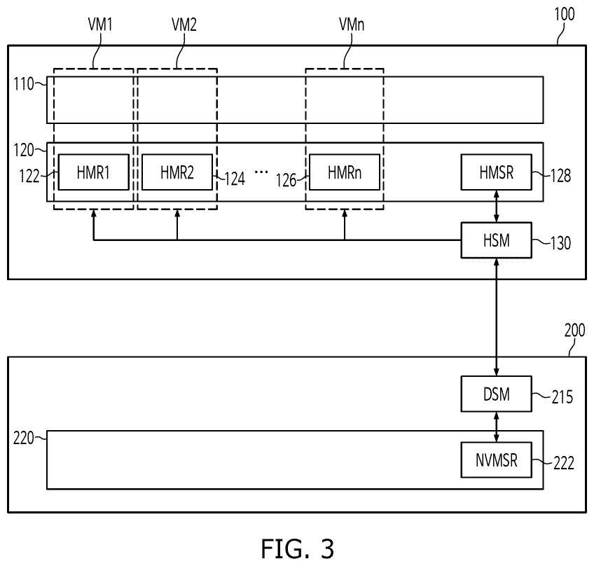

FIG. 3 is a block diagram illustrating an example of a storage system for performing multi-party computations according to one embodiment of the present disclosure. Hereinafter, any overlapping content with that described above with reference to FIGS. 1 and 2 will be omitted or briefly described, and explanation will be given with a focus on the added/changed parts.

In order for multi-party computations to be performed securely, secret values (e.g., personal data, partial triplets, intermediate computation results, etc.) of each tenant VM1, VM2, . . . , or VMn should be protected from exposure, and an isolated environment should be provided so that the computations of respective tenants VM1, VM2, . . . , and VMn do not interfere with each other. To this end, confidential computing technology may be applied to a storage system to provide a trusted execution environment (TEE).

Referring to FIG. 3, the storage system may include a host device 100 and a storage device 200 configured to transmit and receive data with the host device 100.

According to one embodiment, the host device 100 may include a host controller 110, host memory 120, and a host security manager 130. The host security manager 130 may include hardware and/or software modules that manage the security of the host device 100. That is, the host security manager 130 may be a trusted component of the host device 100. Although the host security manager 130 is depicted as a separate component from the host controller 110 and the host memory 120, the scope of the present disclosure is not limited thereto, and the host security manager 130 may be included in the host controller 110 and/or the host memory 120.

According to one embodiment, the host memory 120 may include a security region 128 accessible only to the host security manager 130. In one embodiment, the host security manager 130 may set up a security region 128 within the host memory 120 that only the host security manager 130 may access.

Additionally or alternatively, in an environment where a plurality of tenants VM1, VM2, . . . , VMn (where n is a natural number greater than or equal to 2) use the host device 100, a security region may be set for each of the plurality of tenants VM1, VM2, . . . , VMn. For example, the host memory 120 may include memory areas 122, 124 and 126 where access is permitted only to each associated tenant VM1, VM2, . . . , or VMn. As a specific example, the host security manager 130 may set a first host memory area 122, where access is permitted only to the first tenant VM1, within the host memory 120. Additionally, the host security manager 130 may set a second host memory area 124, where access is permitted only to a second tenant VM2 that is different from the first tenant VM1, within the host memory 120. Here, the first host memory area 122 and the second host memory area 124 may be different areas within the host memory 120. In this way, the host security manager 130 may set different host memory areas 122, 124 and 126, where access is permitted only to each tenant VM1, VM2, . . . , or VMn, in some areas of the host memory 120.

The host security manager 130 may manage a mapping table that includes addresses of security regions within the host memory 120, addresses of host memory areas 122, 124 and 126 associated with each tenant VM1, VM2, . . . , VMn, encryption key information associated with each tenant VM1, VM2, . . . , VMn, etc.

According to one embodiment, the storage device 200 may include a device security manager 215 and a non-volatile memory 220. The device security manager 215 may include hardware and/or software modules that manage the security of the storage device 200. That is, the device security manager 215 may be a trusted component of the storage device 200.

In one embodiment, the non-volatile memory 220 may include a security region 222 that only the device security manager 215 may access. For example, the device security manager 215 may set a security region 222, which only the device security manager 215 may access, within the non-volatile memory 220.

The host security manager 130 may perform mutual authentication with the device security manager 215 using a security protocol (e.g., Security Protocol and Data Model (SPDM), etc.). Through this, the host security manager 130 and the device security manager 215 may become trusted configurations of the host device 100 and the storage device 200. That is, the trusted area of the host device 100 may be expanded. According to one embodiment, a secure path may be formed between the host security manager 130 and the device security manager 215, and the host security manager 130 and the device security manager 215 may transmit and receive data, commands, etc. through the secure path.

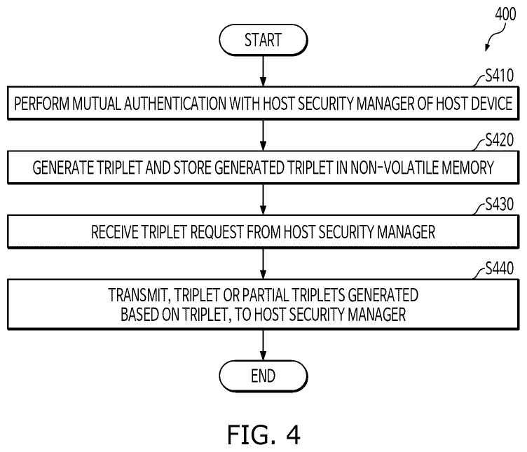

According to one embodiment, the device security manager 215 may generate a triplet and store the generated triplet in the security region 222 of the non-volatile memory 220. The generation of a triplet by the device security manager 215 may be performed while the storage controller (e.g., 210 of FIG. 1) is not performing data writing/reading. Additionally, the device security manager 215 may, in response to receiving a triplet request from the host security manager 130, transmit a triplet or a partial triplet generated based on the triplet to the host security manager 130. The related configuration is described in more detail later with reference to FIGS. 4 to 15.

As described above, as a storage device performs generation and management of triplets for multi-party computations by offloading, resources of a host device may be saved, processing speed may be improved, and performance may be optimized. Additionally, the efficiency of the storage system may be increased by generating triplets while the storage device 200 is not performing data recording/reading.

In FIG. 3, it is illustrated that the host device 100 includes one host controller 110, and all tenants VM1, VM2, . . . , VMn share and use the same host controller 110, but this is only for convenience of explanation and the scope of the present disclosure is not limited thereto. The host device 100 may include a plurality of host controllers and/or at least some of the plurality of tenants VM1, VM2, . . . , VMn may use different host controllers. In addition, in FIG. 3, the host device 100 includes one host memory 120, and all tenants VM1, VM2, . . . , VMn and the host security manager 130 share and use the same host memory 120, but this is only for convenience of explanation, and the scope of the present disclosure is not limited thereto. The host device 100 may include a plurality of host memories and/or the host security manager 130 and at least some of the plurality of tenants VM1, VM2, . . . , VMn may use different host memories.

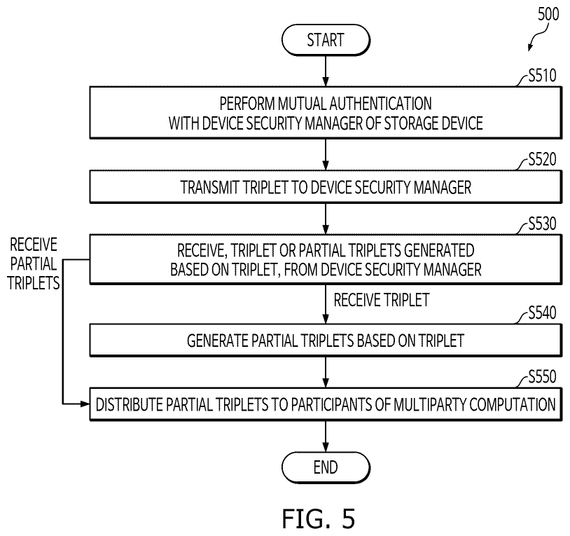

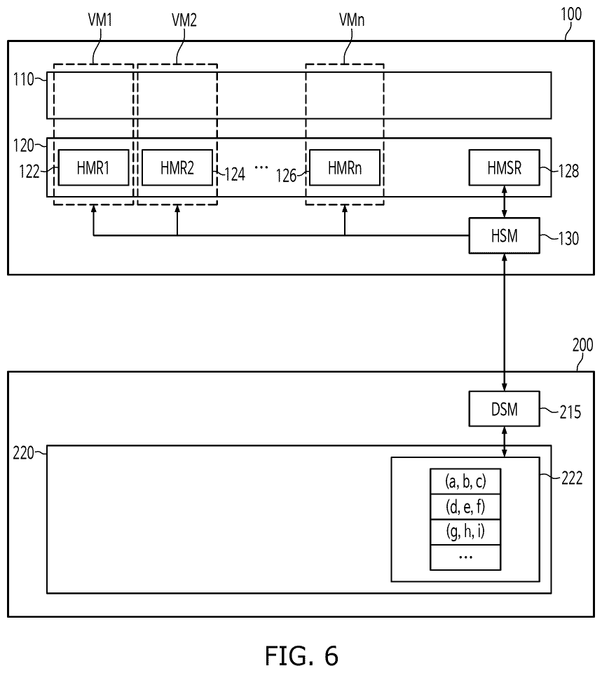

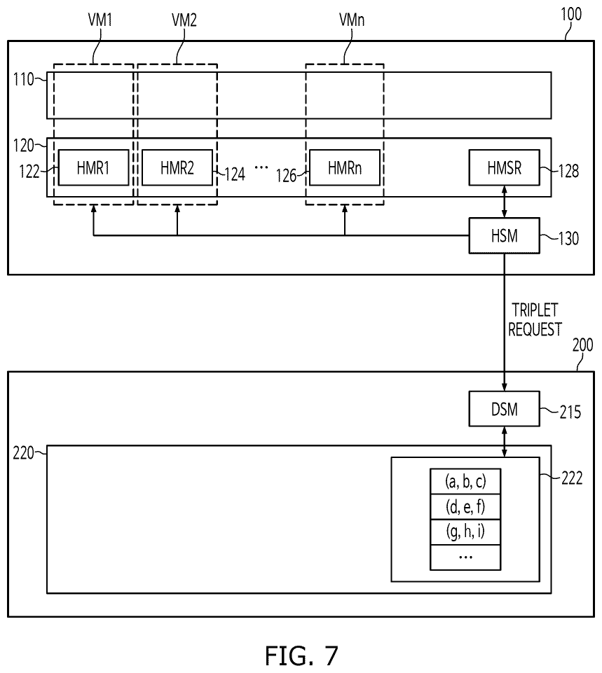

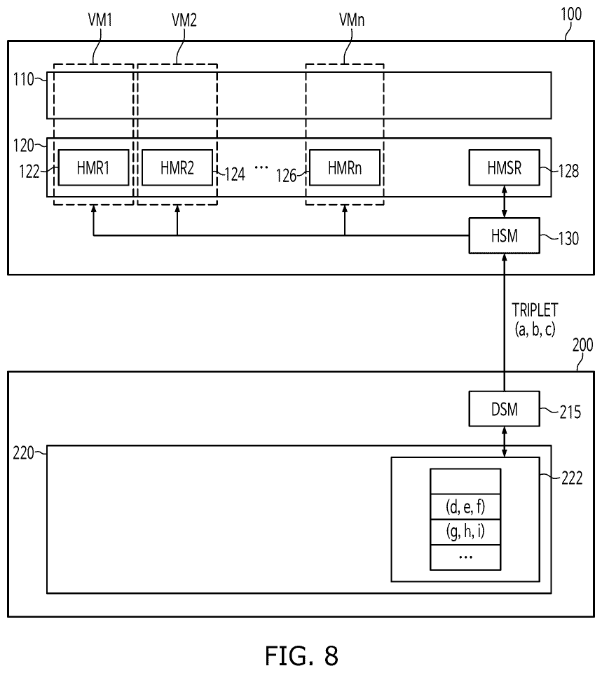

FIG. 4 is a flowchart illustrating an example of an operating method 400 of a storage device according to one embodiment of the present disclosure, FIG. 5 is a flowchart illustrating an example of an operating method 500 of a host device according to one embodiment of the present disclosure, and FIGS. 6 to 9 are block diagrams illustrating examples of the operation of a storage system according to one embodiment of the present disclosure. In the following, any overlapping content with that described above will be omitted or briefly described, and explanation will be given with a focus on the added/changed parts with reference to FIGS. 1 to 3.

Referring to FIG. 4, an operation method 400 of a storage device may be performed by a device security manager 215 of a storage device. The device security manager 215 of the storage device may first perform mutual authentication with the host security manager of the host device using a security protocol (S410).

Thereafter, the device security manager 215 may generate a triplet and store the triplet in the non-volatile memory (S420). For example, the device security manager may create a triplet and store the triplet in a security region of the non-volatile memory that only the device security manager may access. In one embodiment, the device security manager may generate triplets while the storage controller is not performing data write/read operations at the request of the host device.

As a specific example, as illustrated in FIG. 6, the device security manager 215 may generate triplets “(a, b, c), (d, e, f), (g, h, i)”, etc., while not performing a data write/read operation according to the request of the host device 100, and may store the generated triplets in the security region 222 of the non-volatile memory 220. According to one embodiment, the device security manager 215 may further generate random values necessary to generate partial triplets and store the generated random values in the security region 222 of the non-volatile memory 220.

Referring again to FIG. 4, the device security manager 215 may receive a triplet request from the host security manager (S430), and then transmit a triplet or partial triplets generated based on the triplet to the host security manager in response to receiving the triplet request from the host security manager (S440).

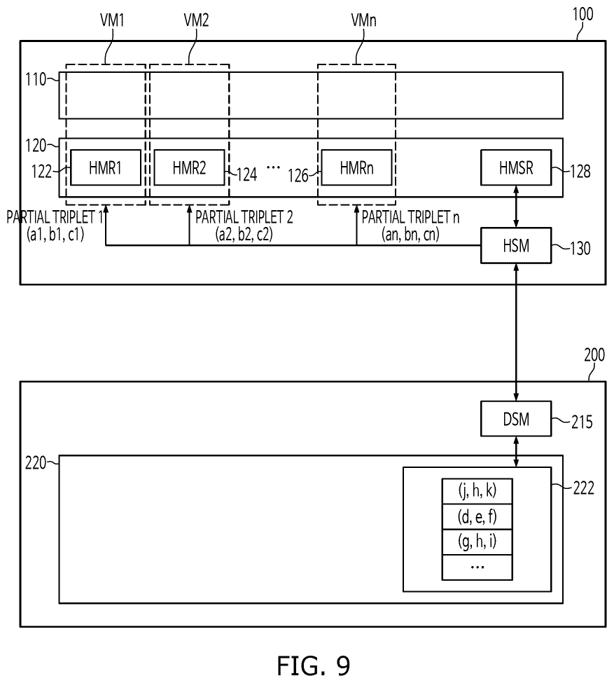

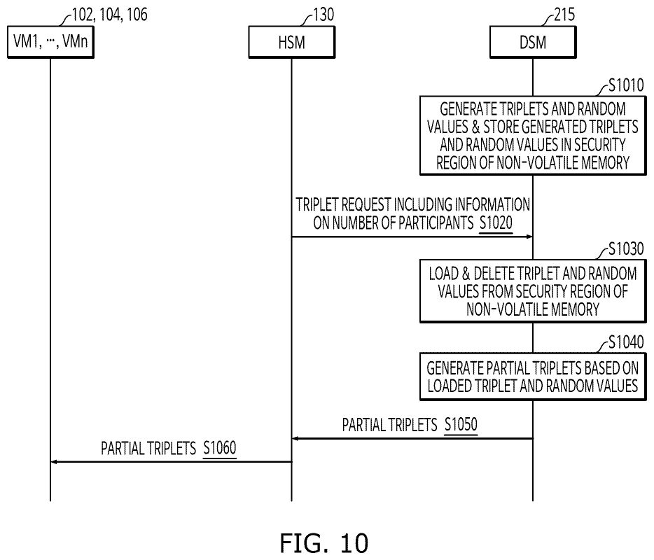

As a specific example, as illustrated in FIG. 7, the device security manager 215 may receive a triplet request from the host security manager 130. In response to the request, the device security manager 215 may load the triplet “(a, b, c)” (e.g., load it into the buffer memory 216 of FIG. 1 or a separate buffer memory (not shown) of the device security manager 215), as illustrated in FIG. 8, delete the triplet “(a, b, c)” from the security region 222 of the non-volatile memory 220, and transmit the triplet “(a, b, c)” to the host security manager 130. As another specific example, the device security manager 215 may transmit a triplet and random values to the host security manager 130. As another specific example, the device security manager 215 may generate partial triplets based on the triplet and random values and transmit the generated partial triplets to the host security manager 130. Various embodiments related to this are described in more detail below with reference to FIGS. 10 to 15. According to one embodiment, the triplet, random values and/or partial triplets may be transmitted through a secure path established between the device security manager 215 and the host security manager 130.

Referring to FIG. 5, the operation method 500 of the host device may be performed by the host security manager 130 of the host device. The host security manager 130 may first perform mutual authentication with the device security manager of the storage device using a security protocol (S510).

Thereafter, the host security manager 130 may send a triplet request to the device security manager (S520) and receive a triplet or partial triplets generated based on the triplet from the device security manager (S530).

As a specific example, as illustrated in FIG. 7, the host security manager 130 may transmit a triplet request to the device security manager 215. Thereafter, the host security manager 130 may receive a triplet TRIPLET (a, b, c) from the device security manager 215, as illustrated in FIG. 8. As another specific example, the host security manager 130 may receive a triplet and random values from the device security manager 215. As another specific example, the host security manager 130 may also receive partial triplets from the device security manager 215. Various embodiments related to this are described in more detail below with reference to FIGS. 10 to 15. According to one embodiment, the triplet, random values and/or partial triplets may be received through a secure path established between the host security manager 130 and the device security manager 215.

Referring to FIG. 5 again, when the host security manager receives a triplet from the device security manager, the host security manager may generate a partial triplet based on the triplet (S540) and distribute the partial triplets to the participants of the multi-party computation (S550). On the other hand, if the host security manager receives partial triplets from the device security manager, the received partial triplets may be distributed to the participants of the multi-party computation (S550) without the process of generating partial triplets (S540).

As a specific example, as illustrated in FIG. 9, the host security manager 130 may generate partial triplets PARTIAL TRIPLET 1 (a1, b1, c1), PARTIAL TRIPLET 2 (a2, b2, c2), . . . , PARTIAL TRIPLET n (an, bn, cn) based on the received triplet TRIPLET (a, b, c) and distribute the generated partial triplets to tenants VM1, VM2, . . . , VMn (where n is a natural number greater than or equal to 2) that are participants in the multi-party computation. In some embodiments, distributing partial triplets to tenants VM1, VM2, . . . , VMn may mean storing each partial triplet in a host memory area 122, 124 or 126 associated with each tenant VM1, VM2, . . . or VMn. Each tenant VM1, VM2, . . . or VMn may perform computations using the distributed partial triplets.

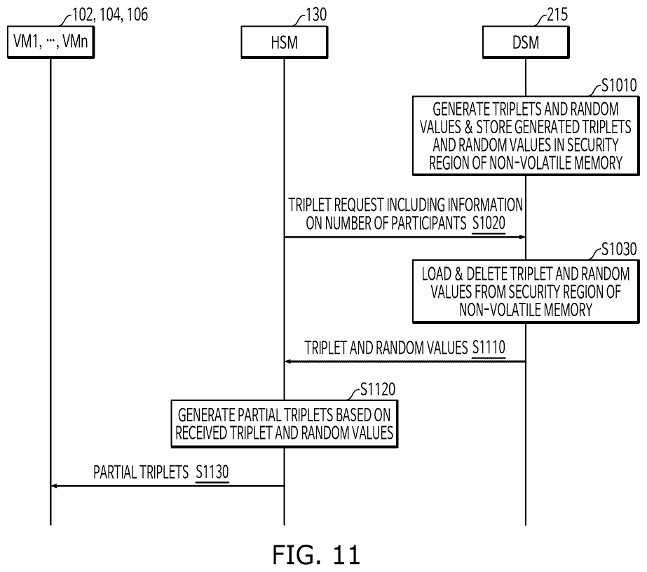

FIGS. 10 and 11 are diagrams illustrating examples of a method of operating a storage system according to some embodiments of the present disclosure. In the following, any content that overlaps with the above-described content will be omitted or briefly described, and explanation will be given with a focus on the added/changed parts with reference to FIGS. 1 to 9.

Referring to FIGS. 10 and 11, a device security manager 215 according to one embodiment may generate random values required to generate triplets and partial triplets and store the generated triplets and partial triplets in a security region of a non-volatile memory (S1010). According to one embodiment, the device security manager 215 may generate triplets and random values while the storage controller is not performing data write/read operations at the request of the host device.

Thereafter, the host security manager 130 may transmit a triplet request including information about the number of participants in the multi-party computation (e.g., n, where n is a natural number greater than or equal to 2) to the device security manager 215 (S1020). For example, the host security manager 130 may send a triplet request when distribution of partial triplets is required (e.g., when tenants 102, 104 and 106 of the host device, which are participants in a multi-party computation, perform a multiplication operation. In response to receiving a triplet request from the host security manager 130, triplets and random values may be loaded from the security region of the non-volatile memory (e.g., may be loaded to a buffer memory 216 of FIG. 1 or a separate buffer memory (not shown) of the device security manager 215), and the loaded triplets and random values may be deleted from the security region of the non-volatile memory (S1030). For example, the device security manager 215 may load one triplet and three times the number of participants minus one (e.g., 3(n−1) random values), and delete the loaded triplet and random values from the security region of the non-volatile memory.

In one embodiment, the triplet request may further include information about the number of triplets required (e.g., m, where m is a natural number). That is, the triplet request may include information about the number of participants (e.g., n, where n is a natural number greater than or equal to 2) and information about the number of triplets required. In this case, the device security manager 215 may load as many triplets as the number of triplets required (e.g., m triplets) and as many random values as the number of participants minus 1 multiplied by three times the number of triplets required (e.g., 3m(n−1) random values), and may delete the loaded triplets and random values from the security region of the non-volatile memory.

According to one embodiment, the device security manager 215 may generate partial triplets based on the loaded triplets and random values, as illustrated in FIG. 10 (S1040).

For example, the device security manager 215 may generate as many partial triplets as the number of participants (e.g., n partial triplets) based on a loaded triplet and as many random values as three times the number of participants minus one.

In another example where the triplet request further includes information on the number of necessary triplets, the device security manager 215 may generate as many partial triplets sets, which include partial triplets as the number of participants (e.g., n partial triplets), as the number of necessary triplets (e.g., m partial triplet sets, that is, n×m partial triplets), based on as many triplets as the number of loaded necessary triplets, and as many random values as 3×the number of necessary triplets×(the number of participants−1).

Additionally, the device security manager 215 may transmit the generated partial triplets (e.g., n partial triplets or n×m partial triplets) to the host security manager 130 (S1050). The host security manager 130 may distribute the received partial triplets to the tenants 102, 104 and 106 who are participants in the multi-party computation (S1060).

Alternatively, the device security manager 215 may transmit the loaded triplets and random values to the host security manager 130 instead of generating the partial triplets directly, as illustrated in FIG. 11 (S1110).

For example, the device security manager 215 may send one loaded triplet and as many random values as 3×(the number of participants minus one), to the host security manager 130.

In another example where the triplet request further includes information on the number of necessary triplets, the device security manager 215 may send as many triplets as the number of loaded necessary triplets, and as many random values as 3×the number of necessary triplets×(the number of participants−1), to the host security manager 130.

The host security manager 130 may generate partial triplets based on the received triplets and random values (S1120).

For example, the host security manager 130 may generate as many partial triplets as the number of participants (e.g., n partial triplets) based on a received triplet and as many random values as three times the number of participants minus one.

In another example where the triplet request further includes information on the number of necessary triplets, the host security manager 130 may generate as many partial triplets sets, which include as many partial triplets as the number of participants (e.g., n partial triplets), as the number of necessary triplets (e.g., m partial triplet sets, that is, n×m partial triplets), based on as many triplets as the number of received necessary triplets, and as many random values as 3×the number of necessary triplets×(the number of participants−1).

Thereafter, the host security manager 130 may distribute the generated partial triplets to the tenants 102, 104 and 106 which are participants in the multi-party computation (S1130).

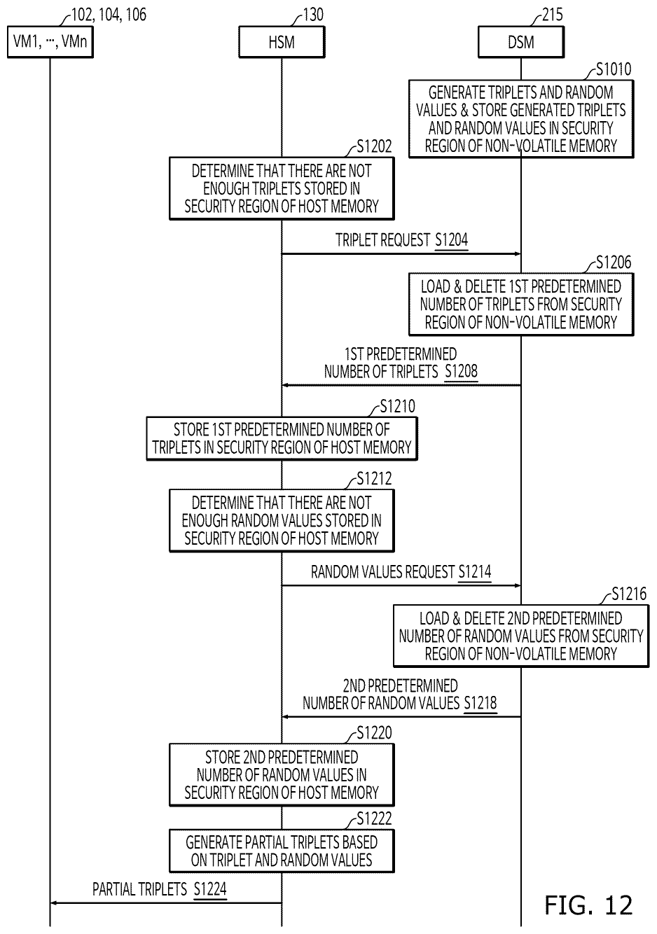

FIG. 12 is a diagram illustrating an example of an operating method of a storage system according to another embodiment of the present disclosure. In the following, any overlapping content with that described above will be omitted or briefly described, and explanation will be given with a focus on the added/changed parts with reference to FIGS. 1 to 11.

According to one embodiment, the device security manager 215 may transmit a predetermined number of triplets and/or random values to the host security manager 130 whenever the device security manager 215 receives a triplet request and/or a random value request from the host security manager 130. The host security manager 130 may store the received triplets and/or random values in the security region of the host memory. The host security manager 130 may load the stored triplets and random values whenever distribution of partial triplets is required, generate partial triplets, and distribute the generated partial triplets to tenants 102, 104 and 106. Additionally, the host security manager 130 may transmit a triplet request and/or a random value request to the device security manager 215 whenever it is determined that the triplets and/or random values stored in the security region of the host memory are insufficient.

Specifically, referring to FIG. 12, the device security manager 215 according to one embodiment may generate triplets and random values required to generate partial triplets, and store the generated triplets and random values in the security region of the non-volatile memory (S1010).

In response to determining that the triplets stored in the security region of the host memory S1202 are not sufficient, the host security manager 130 may transmit a triplet request to the device security manager 215 (S1204). In one embodiment, a triplet request may not include information about the number of participants in a multi-party computation. In response to receiving a triplet request from the host security manager 130, the device security manager 215 may load a first predetermined number of triplets from the security region of the non-volatile memory, and delete the loaded triplets from the security region of the non-volatile memory (S1206). Thereafter, the device security manager 215 may transmit the first predetermined number of loaded triplets to the host security manager 130 (S1208). The host security manager 130 may store the received triplets in the security region of the host memory (S1210).

In response to determining that there is a shortage of random values stored in the security region of the host memory (S1212), the host security manager 130 may transmit a random value request to the device security manager 215 (S1214). In response to receiving a random value request from the host security manager 130, the device security manager 215 may load a second predetermined number of random values from the security region of the non-volatile memory, and delete the loaded random values from the security region of the non-volatile memory (S1216). Thereafter, the device security manager 215 may transmit the second predetermined number of loaded random values to the host security manager 130 (S1218). The host security manager 130 may store the received random values in the security region of the host memory (S1220).

Thereafter, the host security manager 130 may generate partial triplets based on the triplets and random values stored in the security region of the host memory when distribution of partial triplets is required (e.g., when tenants 102, 104 and 106 of the host device, which are participants in a multi-party computation, perform a multiplication operation) (S1222). As a specific example, the host security manager 130 may generate as many partial triplets (e.g., n partial triplets) as the number of participants in the multi-party computation, based on one triplet stored in the security region of the host memory, and as many random values as 3×(the number of participants minus one) (e.g., 3(n−1) random values). Additionally, the host security manager 130 may distribute the generated partial triplets to tenants 102, 104 and 106 which are participants in the multi-party computation (S1224).

The host security manager 130 may subsequently transmit a triplet request and/or a random value request to the device security manager 215 whenever the host security manager 130 determines that the number of triplets and/or random values stored in the security region of the host memory are insufficient.

In FIG. 12, steps S1202 to S1210 related to a triplet request are illustrated as being performed before steps S1212 to S1220 related to a random value request, but the embodiment is not limited to this example, and steps S1202 to S1210 related to the triplet request may be performed after steps S1212 to S1220 related to the random value request, or at least a part of steps S1202 to S1210 related to the triplet request and at least a part of steps S1212 to S1220 related to the random value request may be performed in parallel.

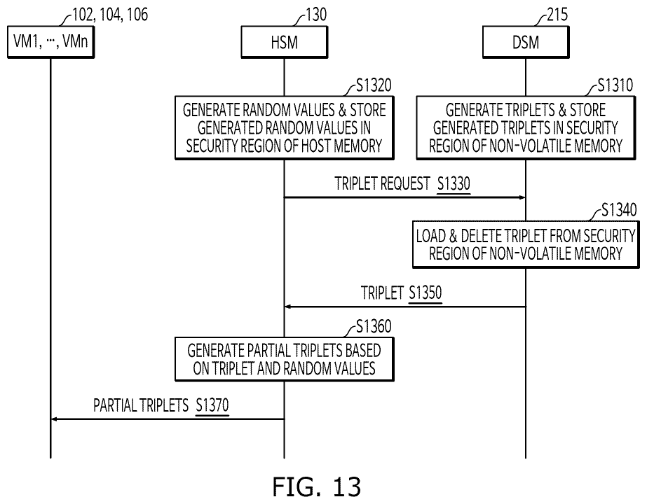

FIG. 13 is a diagram illustrating an example of a method of operating a storage system according to another embodiment of the present disclosure. In the following, any overlapping content with that described above will be omitted or briefly described, and explanation will be given with a focus on the added/changed parts with reference to FIGS. 1 to 12.

Referring to FIG. 13, a device security manager 215 according to one embodiment may generate triplets and store the generated triplets in the security region of the non-volatile memory (S1310). Additionally, the host security manager 130 may generate random values required to generate partial triplets and store the generated random values in the security region of the host memory (S1320).

The host security manager 130 may send a triplet request (S1330). In one embodiment, a triplet request may not include information about the number of participants in a multi-party computation. In response to receiving a triplet request from the host security manager 130, the device security manager 215 may load a triplet from the security region of the non-volatile memory and delete the loaded triplet from the security region of the non-volatile memory (S1340). For example, the device security manager 215 may load a triplet from the security region of the non-volatile memory and delete the loaded triplet from the security region of the non-volatile memory.

As another example, a triplet request may include information about the number of triplets required (e.g., m, where m is a natural number). In this case, the device security manager 215 may load as many triplets as the required number of triplets (e.g., m triplets) from the security region of the non-volatile memory, and delete the loaded triplets from the security region of the non-volatile memory.

Thereafter, the device security manager 215 may transmit the loaded triplet to the host security manager 130 (S1350).

The host security manager 130 may generate as many partial triplets as the number of participants in the multi-party computation, based on the triplet (e.g., one triplet) received from the device security manager 215, and the random values stored in the security region of the host memory (e.g., 3(n−1) random values among the random values stored in the security region of the host memory, where n is the number of participants) (S1360).

In another example where the triplet request further includes information on the number of necessary triplets (e.g., m, where m is a natural number), the host security manager 130 may generate as many partial triplets sets, which include as many partial triplets as the number of participants of the multi-party computation, as the number of necessary triplets (e.g., m partial triplet sets, that is, n×m partial triplets), based on as many triplets as the number of received necessary triplets (e.g., m triplets), and random values stored in the security region of the host memory (e.g., 3m(n−1) random values among random values stored in the security region of the host memory, where n is the number of participants).

Additionally, the host security manager 130 may distribute the generated partial triplets to tenants 102, 104 and 106 (S1370).

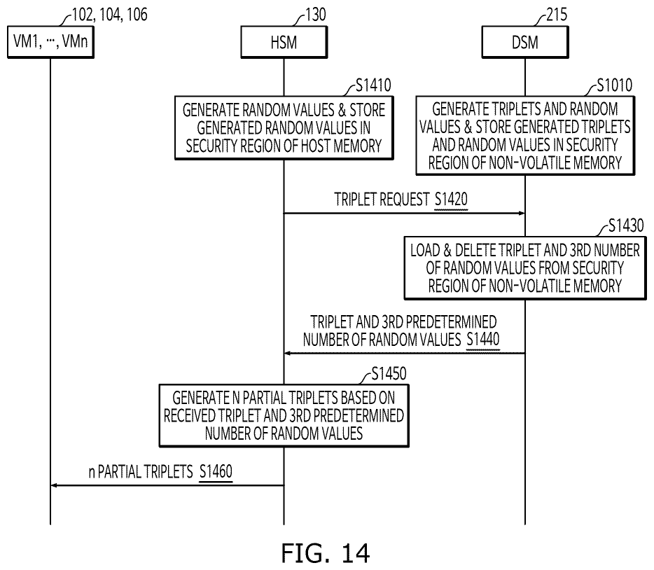

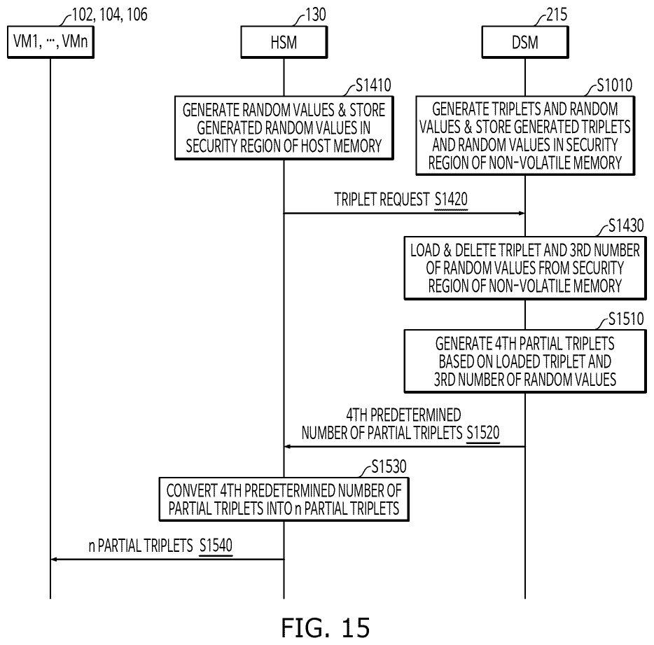

FIGS. 14 and 15 are diagrams illustrating examples of a method of operating a storage system according to further embodiments of the present disclosure. In the following, any overlapping content with that described above will be omitted or briefly described, and explanation will be given with a focus on the added/changed parts with reference to FIGS. 1 to 13.

In some embodiments, in response to receiving the triplet request from the host security manager 130, the device security manager 215 may transmit a third predetermined number of random values or a fourth predetermined number of partial triplets to the host security manager 130. The host security manager 130 may generate as many partial triplets as the number of participants in the multi-party computation based on the received random values or partial triplets, and distribute the generated partial triplets to the participating tenants 102, 104 and 106.

Specifically, referring to FIGS. 14 and 15, a device security manager 215 according to one embodiment may generate random values required to generate triplets and partial triplets, and store the generated random values in a security region of a non-volatile memory (S1010). Additionally, the host security manager 130 may generate random values required to generate partial triplets, and store the generated random values in a security region of the host memory (S1410).

The host security manager 130 may send a triplet request (S1420). In one embodiment, the triplet request may not include information about the number of participants in a multi-party computation. In response to receiving a triplet request from the host security manager 130, the device security manager 215 may load a triplet (e.g., one triplet) and a third predetermined number of random values from the security region of the non-volatile memory, and delete the loaded triplet and random values from the security region of the non-volatile memory (S1430).

According to one embodiment, the device security manager 215 may transmit the loaded triplet and a third predetermined number of random values to the host security manager 130 as illustrated in FIG. 14 (S1440). The host security manager 130 may generate as many partial triplets as the number of participants (e.g., n partial triplets, where n is the number of participants), based on the received triplets and a third predetermined number of random values (S1450).

For example, if more random values are received than are required to generate as many partial triplets as the number of participants (e.g., if the third predetermined number>3(n−1)), the device security manager 215 may generate as many partial triplets as the number of participants using only as many random values as are required from among the received random values. As another example, if fewer random values are received than are needed to generate as many partial triplets as the number of participants (e.g., if the third predetermined number<3(n−1)), the device security manager 215 may further use random values stored in the security region of the host memory to generate as many partial triplets as the number of participants. As another example, if as many random values as are required to generate as many partial triplets as the number of participants are received (e.g., if the third predetermined number=3(n−1)), the device security manager 215 may generate the partial triplets using the received random values. Thereafter, the device security manager 215 may distribute the generated partial triplets to the tenants 102, 104 and 106 which are participants in the multi-party computation (S1460).

Alternatively, the device security manager 215 may generate a fourth predetermined number (e.g., k) of partial triplets based on the loaded triplets and a third predetermined number (e.g., 3(k−1)) of random values (S1510), as illustrated in FIG. 15, and transmit the generated fourth predetermined number of partial triplets to the host security manager 130 (S1520). The host security manager 130 may convert the received fourth predetermined number of partial triplets into as many partial triplets as the number of participants in the multi-party computation (S1530).

For example, if the number of partial triplets received is greater than the number of participants in the multi-party computation (e.g., if the fourth predetermined number is >n, where n is the number of participants), the host security manager 130 may convert some of the received fourth predetermined number of partial triplets into as many partial triplets as the number of participants in the multi-party computation by adding the partial triplets together. As another example, if fewer partial triplets are received than the number of participants in a multi-party computation (e.g., if a fourth predetermined number<n), the host security manager 130 may generate as many partial triplets as the number of participants in the multi-party computation based on a fourth predetermined number of partial triplets and random values stored in the security region of the host memory. As another example, if as many partial triplets as the number of participants in a multi-party computation are received (e.g., if the fourth predetermined number=n), the host security manager 130 may use the received fourth predetermined number of partial triplets as is. Thereafter, the device security manager 215 may distribute as many partial triplets as the number of participants in the multi-party computation to the tenants 102, 104 and 106 which are participants in the multi-party computation (S1540).

FIGS. 4 to 15 and the processes described above with reference to FIGS. 4 to 15 are only some examples of the present disclosure and may be implemented differently in other embodiments. For example, in some embodiments, the order of each step may be changed, some steps may be added/changed/omitted, at least some steps may be performed repeatedly, at least some steps may be performed simultaneously, or the performers of at least some steps may be changed.

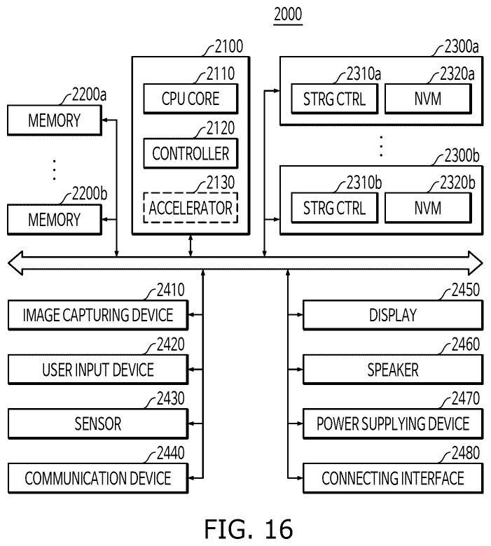

FIG. 16 is an exemplary block diagram illustrating a storage system 2000 according to one embodiment of the present disclosure. Referring to FIG. 16, a storage system 2000 according to one embodiment may be basically a mobile system such as a mobile phone, a smart phone, a tablet personal computer, a wearable device, a healthcare device, or an Internet of Things (IoT) device. However, the system 2000 of FIG. 16 is not necessarily limited to a mobile system, and may be a personal computer, a laptop computer, a server, a media player, or an automotive device such as a navigation system.

The system 2000 may include a main processor 2100, a memory 2200a or 2200b, and a storage device 2300a or 2300b, and may additionally include one or more of an image capturing device 2410, a user input device 2420, a sensor 2430, a communication device 2440, a display 2450, a speaker 2460, a power supplying device 2470, and a connecting interface 2480.

The main processor 2100 may control the overall operation of the system 2000, more specifically, the operation of other components that make up the system 2000. Such a main processor 2100 may be implemented as a general-purpose processor, a dedicated processor, or an application processor.

The main processor 2100 may include one or more CPU cores 2110 and may further include a controller 2120 for controlling memories 2200a and 2200b and/or storage devices 2300a and 2300b. In some embodiments, the main processor 2100 may further include an accelerator 2130, which is a dedicated circuit for high-speed data computations such as AI artificial intelligence data computations. The accelerator 2130 may include a graphics processing unit (GPU), a neural processing unit (NPU), and/or a data processing unit (DPU), and may be implemented as a separate chip that is physically independent from other components of the main processor 2100.

The memories 2200a and 2200b may be used as a main memory device of the system 2000 and may include volatile memories such as SRAM and/or DRAM, but may also include non-volatile memories such as a flash memory, PRAM and/or RRAM. The memories 2200a and 2200b may also be implemented within the same package as the main processor 2100.

The storage device 2300a or 2300b may be a storage device 200 according to the embodiments described above with reference to FIGS. 1 to 15. The storage device 2300a or 2300b may function as a non-volatile storage device that stores data regardless of whether power is supplied, and may have a relatively large storage capacity compared to the memory 2200a or 2200b. The storage device 2300a or 2300b may include a storage controller 2310a or 2310b and a non-volatile memory 2320a or 2320b that stores data under the control of the storage controller 2310a or 2310b. The non-volatile memory 2320a or 2320b may include a flash memory of a 2-dimensional (2D) structure or a 3-dimensional (3D) vertical NAND (V-NAND) structure, but may also include other types of non-volatile memories such as PRAM and/or RRAM.

The storage device 2300a or 2300b may be included in the system 2000 physically separated from the main processor 2100, or may be implemented within the same package as the main processor 2100. In addition, the storage device 2300a or 2300b may have a form such as a solid state drive (SSD) or a memory card, and may be detachably connected to other components of the system 2000 through an interface such as a connection interface 2480 to be described later. Such storage devices 2300a and 2300b may be devices to which standard specifications such as Universal Flash Storage (UFS), embedded multi-media card (eMMC) or non-volatile memory express (NVMe) are applied, but are not necessarily limited thereto.

The image capturing device 2410 may capture still images or moving images and may be a camera, a camcorder, and/or a webcam.

The user input device 2420 may receive various types of data input from a user of the system 2000, and may be a touch pad, a keypad, a keyboard, a mouse, and/or a microphone.

The sensor 2430 may detect various types of physical quantities that may be obtained from the outside of the system 2000 and convert the detected physical quantities into electrical signals. Such a sensor 2430 may be a temperature sensor, a pressure sensor, an illuminance sensor, a position sensor, an acceleration sensor, a biosensor, and/or a gyroscope sensor.

The communication device 2440 may transmit and receive signals between other devices outside the system 2000 according to various communication protocols. Such a communication device 2440 may be implemented including an antenna, a transceiver, and/or a modem.

The display 2450 and the speaker 2460 may function as output devices that output visual information and auditory information, respectively, to the user of the system 2000.

The power supply unit 2470 may appropriately convert power supplied from a battery (not shown) built in the system 2000 and/or an external power source, and supply the converted power to each component of the system 2000.

The connection interface 2480 may provide a connection between the system 2000 and an external device, which is connected to the system 2000 and is able to exchange data with the system 2000. The connection interface 2480 may be implemented in various interface methods such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, universal serial bus (USB), secure digital (SD) card, multi-media card (MMC), eMMC, UFS, embedded universal flash storage (eUFS), compact flash (CF) card interface, etc.

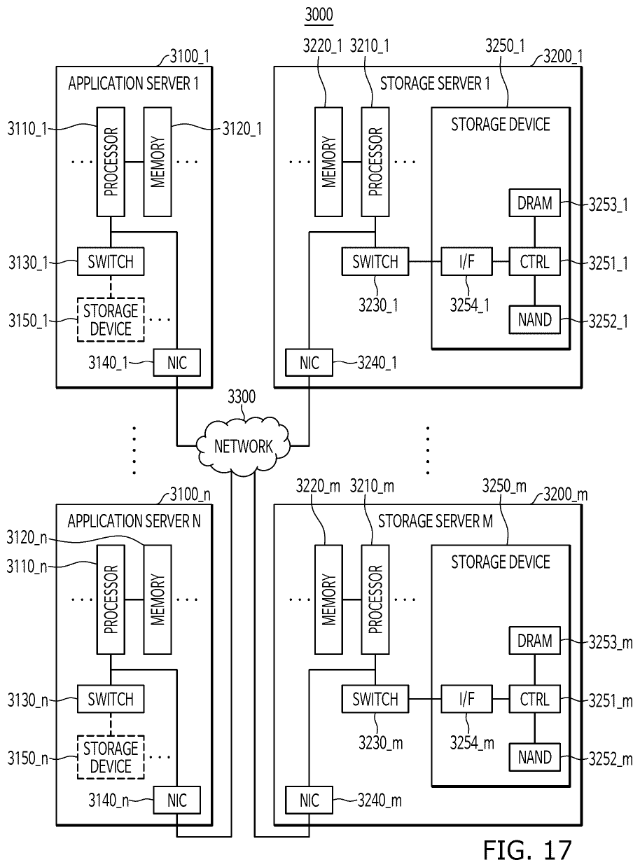

FIG. 17 is an exemplary block diagram for explaining a data center 3000 to which a storage device (3250_1 to 3250_m, where m is a natural number) according to one embodiment of the present disclosure is applied. Referring to FIG. 17, a data center 3000 is a facility that collects various types of data and provides services, and may also be referred to as a data storage center. The data center 3000 may be a system for operating a search engine and database, and may be a computing system used in a company such as a bank, or a government agency. The data center 3000 may include application servers 3100_1 to 3100_n (n is a natural number) and storage servers 3200_1 to 3200_m. The number of application servers 3100_1 to 3100_n and the number of storage servers 3200_1 to 3200_m may be variously selected depending on the embodiment, and the number of application servers 3100_1 to 3100_n and the number of storage servers 3200_1 to 3200_m may be different from each other.

The application server 3100_n or the storage server 3200_m may include at least one of processors 3110_n and 3210_m and memories 3120_n and 3220_m. Taking the storage server 3200_m as an example, the processor 3210_m may control the overall operation of the storage server 3200_m and access the memory 3220_m to execute commands and/or data loaded into the memory 3220_m. The memory 3220_m may be double data rate synchronous DRAM (DDR SDRAM), high bandwidth memory (HBM), hybrid memory cube (HMC), dual in-line memory module (DIMM), optane DIMM and/or non-volatile DIMM (NVMDIMM). Depending on the embodiment, the number of processors 3210_m and the number of memories 3220_m included in the storage server 3200_m may be selected in various ways. In one embodiment, the processor 3210_m and the memory 3220_m may provide a processor-memory pair. In one embodiment, the number of processors 3210_m and the number of memories 3220_m may be different from each other. The processor 3210_m may include a single core processor or a multi-core processor. The above description for the storage server 3200_m may be similarly applied to the application server 3100_n. Depending on the embodiment, the application server 3100_n may not include a storage device 3150_n. The storage server 3200_m may include at least one storage device 3250_m. The number of storage devices 3250_m included in the storage server 3200_m may be selected in various ways depending on the embodiment.

Application servers 3100_1 to 3100_n and storage servers 3200_1 to 3200_m may communicate with each other via a network 3300. The network 3300 may be implemented using fibre channel (FC) or Ethernet. At this time, the FC is a medium used for relatively high-speed data transmission, and an optical switch that provides high performance/high availability may be used. Depending on the access method of the network 3300, the storage servers 3200_1 to 3200_m may be provided as file storage, block storage, or object storage.

In one embodiment, the network 3300 may be a storage-only network, such as a storage area network (SAN). For example, the SAN may be an FC-SAN that utilizes an FC network and is implemented according to the FC Protocol (FCP). As another example, the SAN may be an IP-SAN that uses a TCP/IP network and is implemented according to SCSI over TCP/IP or Internet SCSI protocol (iSCSI). In another embodiment, the network 3300 may be a general network, such as a TCP/IP network. For example, the network 3300 may be implemented according to protocols such as FC over Ethernet (FCoE), Network Attached Storage (NAS), and NVMe over Fabrics (NVMe-oF).

Hereinafter, the explanation will focus on the application server 3100_n and the storage server 3200_m. The description of the application server 3100_n may also apply to other application servers, and the description of the storage server 3200_m may also apply to other storage servers.

The application server 3100_n may store data requested to be stored by a user or client in one of the storage servers 3200_1 to 3200_m via the network 3300. Additionally, the application server 3100_n may obtain data requested to be read by a user or client from one of the storage servers 3200_1 to 3200_m through the network 3300. For example, the application server 3100_n may be implemented as a web server or a database management system (DBMS).

The application server 3100_n may access memory or storage devices included in another application server via the network 3300, or may access memories 3220_1 to 3220_m or storage devices 3250_1 to 3250_m included in storage servers 3200_1 to 3200_m via the network 3300. Accordingly, the application server 3100_n may perform various operations on data stored in the application servers 3100_1 to 3100_n and/or the storage servers 3200_1 to 3200_m. For example, the application server 3100_n may execute a command to move or copy data between application servers 3100_1 to 3100_n and/or storage servers 3200_1 to 3200_m. At this time, data may be moved to the memories 3120_1 to 3120_n of the application servers 3100_1 to 3100_n directly or after passing from the storage devices 3250_1 to 3250_m of the storage servers 3200_1 to 3200_m to the memories 3220_1 to 3220m of the storage servers 3200_1 to 3200_m. Data, which moves through the network 3300, may be data encrypted for security or privacy.

The storage devices 3250_1 to 3250_m may be storage devices 200 according to the embodiments described above with reference to FIGS. 1 to 15.

Taking the storage server 3200_m as an example, the interface 3254_m may provide a physical connection between the processor 3210_m and the controller 3251_m and a physical connection between the Network InterConnect (NIC) 3240_m and the controller 3251_m. For example, the interface 3254_m may be implemented in a direct attached storage (DAS) manner that directly connects the storage device 3250_m with a dedicated cable. Further, for example, the connection interface 3254 may be implemented in various interface methods such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, universal serial bus (USB), secure digital (SD) card, multi-media card (MMC), eMMC, UFS, embedded universal flash storage (eUFS), compact flash (CF) card interface, etc.

The storage server 3200_m may further include a switch 3230_m and an NIC 3240_m. The switch 3230_m may selectively connect the processor 3210_m and the storage device 3250_m or selectively connect the NIC 3240_m and the storage device 3250 under the control of the processor 3210_m.

In one embodiment, the NIC 3240_m may include a network interface card, a network adapter, etc. The NIC 3240_m may be connected to a network 3300 via a wired interface, a wireless interface, a Bluetooth interface, an optical interface, etc. The NIC 3240_m may include internal memory, a digital signal processor (DSP), a host bus interface, etc., and may be connected to a processor 3210_m and/or a switch 3230_m via the host bus interface. The host bus interface may be implemented as one of the examples of interfaces 3254_m described above. In one embodiment, the NIC 3240_m may be integrated with at least one of a processor 3210_m, a switch 3230_m, and a storage device 3250_m.

In storage servers 3200_1 to 3200_m or application servers 3100_1 to 3100_n, a processor may program or read data by sending a command to storage devices 3150_1 to 3150_n and 3250_1 to 3250_m or memories 3120_1 to 3120_n and 3220_1 to 3220_m. At this time, the data may be error-corrected data through an error correction code (ECC). The data is data that has undergone a data bus inversion (DBI) or data masking (DM) process, and may include cyclic redundancy code (CRC) information. Data may be data encrypted for security or privacy.

The storage devices 3150_1 to 3150_n and 3250_1 to 3250_m may transmit control signals and command/address signals to the NAND flash memory devices 3252_1 to 3252_m based on a read command received from the processor. Accordingly, when reading data from NAND flash memory devices 3252_1 to 3252_m, the read enable (RE) signal may be input as a data output control signal and play a role in outputting data to the DQ bus. A Data Strobe (DQS) may be generated using the RE signal. A command and an address signal may be latched into the page buffer according to the rising edge or falling edge of the write enable (WE) signal.

The controller 3251_m may control the overall operation of the storage device 3250_m. In one embodiment, the controller 3251_m may include static random access memory (SRAM). The controller 3251_m may write data to the NAND flash 3252_m in response to a write command, or may read data from the NAND flash 3252_m in response to a read command. For example, the write command and/or read command may be provided from a processor 3210_m within a storage server 3200_m, a processor within another storage server, or processors 3110_1 to 3110_n within application servers 3100_1 to 3100_n. DRAM 3253_m may temporarily store (buffer) data to be written to NAND flash 3252_m or data which is read from NAND flash 3252_m. Additionally, DRAM 3253_m may store metadata. Here, metadata is data generated by the controller 3251_m to manage user data or NAND flash 3252_m. The storage device 3250_m may include a secure element (SE) for security or privacy.

Although the embodiments of the present disclosure have been described with reference to the attached drawings, the present disclosure is not limited to the embodiments described above, but may be manufactured in various different forms, and a person skilled in the art to which the present disclosure pertains will understand that the present disclosure may be implemented in other specific forms without changing the technical idea or essential features of the present disclosure. Therefore, it should be understood that the embodiments described above are exemplary in all respects and not limiting.

What is claimed is:

1. A storage system comprising:
a host device; and
a storage device configured to transmit and receive data with the host device,
wherein the host device comprises:
a host memory; and
a host security manager configured to manage security of the host device and to transmit a triplet request to the storage device,
wherein the storage device comprises:
a non-volatile memory; and
a storage controller comprising a device security manager configured to manage security of the storage device, generate a triplet and store the triplet in the non-volatile memory, and transmit the triplet or partial triplets generated based on the triplet to the host security manager in response to receiving the triplet request from the host security manager,
wherein the triplet comprises a pair of numbers containing three numbers for performing a multiplication operation through a multi-party computation (MPC) in the host device, and
wherein the partial triplets contain secret shared values of the triplet, which are distributed to participants of the multi-party computation.

2. The storage system as claimed in claim 1, wherein the device security manager and the host security manager are further configured to perform mutual authentication using a security protocol.

3. The storage system as claimed in claim 1, wherein the storage controller is configured to write data to the non-volatile memory or read data stored in the non-volatile memory according to a request from the host device, and
wherein the device security manager is further configured to generate the triplet while the storage controller is not performing an operation of writing the data or an operation of reading the data.

4. The storage system as claimed in claim 1,
wherein the non-volatile memory comprises a security region accessible by only the device security manager, and
wherein the device security manager is further configured to store the generated triplet in the security region of the non-volatile memory.

5. The storage system as claimed in claim 1, wherein the host security manager is further configured to:
set a first host memory area, to which only a first tenant among the participants of the multi-party computation is allowed for access, in the host memory; and
set a second host memory area, to which only a second tenant among the participants of the multi-party computation is allowed for access, in the host memory, and
wherein the first host memory area and the second host memory area are different areas within the host memory.

6. The storage system as claimed in claim 1, wherein the device security manager is further configured to:
generate random values required to generate the partial triplets; and
store the generated random values in the non-volatile memory.

7. The storage system as claimed in claim 6, wherein the device security manager is further configured to, in response to the receiving the triplet request from the host security manager, generate the partial triplets based on the triplet and the random values, and transmit the generated partial triplets to the host security manager.

8. The storage system as claimed in claim 7,
wherein the triplet request comprises information about a number of the participants, and
wherein the device security manager is further configured to generate partial triplets in a number corresponding to the number of the participants, based on the triplet and the random values.

9. The storage system as claimed in claim 6, wherein the device security manager is further configured to, in response to the receiving of the triplet request from the host security manager, transmit the triplet and the random values to the host security manager.

10. The storage system as claimed in claim 9,
wherein the triplet request comprises information about a number of the participants, and
wherein the device security manager is further configured to, in response to the receiving of the triplet request from the host security manager, transmit the triplet and random values in a number corresponding to 3×(the number of the participants−1), to the host security manager.

11. The storage system as claimed in claim 9, wherein the host security manager is further configured to generate the partial triplets based on the received triplet and the received random values.

12. The storage system as claimed in claim 1, wherein the host memory comprises a security region accessible only by the host security manager.

13. The storage system as claimed in claim 12,
wherein the device security manager is further configured to, in response to the receiving of the triplet request from the host security manager, transmit a first predetermined number of the triplets to the host security manager, and
wherein the host security manager is further configured to:
store the triplet, which is received from the device security manager, in the security region of the host memory; and
transmit a triplet request to the device security manager, in response to determining that triplets stored in the security region of the host memory are insufficient.

14. The storage system as claimed in claim 12,
wherein the device security manager is further configured to:
generate random values required to generate the partial triplets;
store the generated random values in the non-volatile memory; and
transmit a second predetermined number of the random values to the host security manager, in response to receiving a random value request from the host security manager, and
wherein the host security manager is further configured to:
store the random values, which are received from the device security manager, in the security region of the host memory; and
transmit a random value request to the device security manager in response to determining that the random values stored in the security region of the host memory are insufficient.

15. The storage system as claimed in claim 12, wherein the host security manager is further configured to generate random values required to generate the partial triplets and to store the generated random values in the security region of the host memory.

16. The storage system as claimed in claim 15, wherein the host security manager is further configured to generate the partial triplets based on the received triplet and the generated random values.

17. The storage system as claimed in claim 1,
wherein the device security manager is further configured to:
generate random values required to generate the partial triplets;
store the generated random values in the non-volatile memory; and
transmit the triplet and a third predetermined number of random values to the host security manager, in response to the receiving of the triplet request from the host security manager, and
wherein the host security manager is further configured to generate partial triplets in a number corresponding to a number of the participants, based on the received triplet and the received third predetermined number of random values.

18. The storage system as claimed in claim 1,
wherein the device security manager is further configured to:
generate random values required to generate the partial triplets;
store the generated random values in the non-volatile memory; and
in response to the receiving of the triplet request from the host security manager, generate a fourth predetermined number of partial triplets based on the triplet and the random values, and transmit the fourth predetermined number of partial triplets to the host security manager, and
wherein the host security manager is further configured to convert the received fourth predetermined number of partial triplets into partial triplets in a number corresponding to a number of participants.

19. A storage device comprising:
a non-volatile memory; and
a device security manager configured to manage security of the storage device and to perform mutual authentication with a host security manager of a host device, wherein the host device is configured to transmit and receive data with the storage device,
wherein the device security manager is further configured to:
generate a triplet;
store the generated triplet in the non-volatile memory; and
transmit the triplet or partial triplets generated based on the triplet to the host security manager, in response to receiving a triplet request from the host security manager,
wherein the triplet comprises a set of numbers containing three numbers for performing a multiplication operation through a multi-party computation in the host device, and
wherein the partial triplets comprise secret shared values of the triplet, which are distributed to participants of the multi-party computation.

20. A host device comprising:
a host memory; and
a host security manager configured to manage security of the host device and to perform mutual authentication with a device security manager of a storage device, wherein the storage device is configured to transmit and receive data with the host device,
wherein the host security manager is further configured to:
transmit a triplet request to the device security manager; and
receive a triplet or partial triplets generated based on the triplet, from the device security manager, and
wherein the triplet comprises a set of numbers containing three numbers for performing a multiplication operation through a multi-party computation in the host device, and
wherein the partial triplets comprise secret shared values of the triplet, which are distributed to participants of the multi-party computation.
